(19) United States
(12) Patent Application Publication
(10) Pub. No.: US 2006/0290925 A1
(43) Pub. Date: Dec. 28, 2006

(54) Gas monitor device

(75) Inventors: Cyrille Nomine, Annecy (FR); Didier Pierrejean, Groisy (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/447,792

(22) Filed: Jun. 7, 2006

(30) Foreign Application Priority Data
Jun. 8, 2005 (FR) 0551534

(51) Int. Cl. G01J 3/30

(52) U.S. Cl. 356/316

(57) ABSTRACT

The monitor device according to the invention comprises an axial excroissance bounded by a gastight peripheral wall permeable to magnetic fields and connected to a chamber, such as a process chamber, where gaseous species to be monitored are present. A light radiation sensor is placed at the end of the axial chamber excroissance and allows the light to be transported via an optical fiber (4a) to an optical spectrometer. A plasma generator generates a monitoring plasma in the internal space of the axial chamber excroissance. One or more magnets are placed outside the peripheral wall of the axial chamber excroissance and generate a magnetic field near the sensor in order to form a magnetic barrier that prevents the ionized particles of the monitoring plasma from propagating toward the sensor. Thus, the sensor and the chamber are prevented from becoming fouled.

### CROSS-REFERENCE TO RELATED APPLICATIONS

This application is based on French Patent Application No. 0551534 filed Jun. 6, 2005, the disclosure of which is hereby incorporated by reference thereto in its entirety, and the priority of which is hereby claimed under 35 U.S.C. §119.

### BACKGROUND OF THE INVENTION

1. Field of the invention

The present invention relates to devices for monitoring gaseous species, for example those contained in a chamber, by optical emission spectroscopy.

2. Description of the prior art

Such devices for monitoring by optical emission spectroscopy are already known in which the light radiation, emitted by a plasma present in the gas to be analyzed, is used, the optical spectrum of said radiation emitted by the plasma is recorded and the optical spectrum is analyzed in order to deduce therefrom the presence of the gaseous species.

A known example of a gas detector, described in document U.S. Pat. No. 6,643,014, comprises a gastight wall defining an excitation chamber in direct communication with the atmosphere contained in an enclosure in which it is desired to detect the gaseous species present. A plasma is created in this branched-off excitation chamber, by electromagnetic excitation by means of an excitation antenna supplied by a power generator. Alternatively, the excitation may be carried out by a microwave generator. A radiation sensor comprising an optical fiber connected to an optical spectrometer is placed near the plasma-generating zone.

Such devices have drawbacks when they are used to monitor gaseous species since the formation of a plasma favors the generation of deposits on the walls of the excitation chamber. In fact, the plasma formed deposits particles not only on the wall of the excitation chamber, but also on the radiation sensor. This results in a progressive degradation of the light transmission through the optical spectrometer. The deposits formed on the radiation sensor constitute a selective filter that is liable to modify the light spectrum transmitted, producing errors in the monitoring of the gaseous species.

It is therefore necessary to periodically interrupt the operation of the monitor device, in order to clean the inner face of the radiation sensor. For example, when vacuum etching processes are being used, it is necessary to open the chamber to atmosphere and clean the walls by a wet cleaning process, using acids or solvents. After cleaning, the chamber must again be pumped down for two to three hours in order to extract the cleaning gases and vapors, then a series of etching operations must be carried out on test substrates and, finally, normal operation of the etching processes can resume. It will be understood that these operations substantially reduce the overall efficiency of the processes, and substantially increase the production cost.

Moreover, other documents propose various solutions for reducing the risk or the rate of formation of the deposits on a transparent process chamber window for monitoring the gaseous species contained in the chamber by optical emission spectroscopy.

In particular, documents U.S. Pat. No. 6,390,019 and U.S. Pat. No. 6,712,927 describe the use of permanent magnets or electromagnets placed in the internal atmosphere of the process chamber, upstream of the transparent window but downstream of a mask having a small aperture, and thus generating an intense transverse magnetic field that traps the ionized incident particles coming from the plasma, so as to confine them upstream of the window. Such a device still has various drawbacks, in particular the magnets placed inside the process chamber constitute an unacceptable source of additional pollution. This is because, sooner or later, the charged particles trapped in the magnetic field may become deposited on the magnets, creating chemical pollution between the trapped reactive species and the constituent material of the magnets. These new particles thus formed are then a source of contamination for the process itself. The magnets themselves, placed in a vacuum, outgas pollutants. In addition, if the deposits are too great, the magnets have to be changed or cleaned.

To avoid this drawback, document U.S. Pat. No. 6,503,364 describes a device having a hollow tube, one end of which communicates via an opening with a process chamber that includes means for generating a plasma, the optical emission of which it is desired to measure. Fitted at the other end of the hollow tube is a measurement window made of transparent material. A magnetic field is formed near the opening for communication with the process chamber, so as to prevent the plasma from penetrating into the hollow tube. The molecules then adhere to the wall of the chamber near the opening. The device described in that document has the drawback of causing increased pollution of the process chamber.

The object of the present invention is to propose a device for monitoring a gas mixture by optical emission spectroscopy that not only allows a long period of operation of the device without requiring the light radiation sensor to be frequently cleaned, but also avoids any generation of pollution in the chamber which, if it is a process chamber, is liable to disturb the processes.

The monitor device according to the invention must be completely clean and transparent for the processes in which it is fitted.

### SUMMARY OF THE INVENTION

The subject of the invention is a monitor device for monitoring gaseous species contained in a chamber by optical emission spectroscopy, which device comprises:

an axial excroissance joined to said chamber via an open end and bounded by a gastight peripheral wall permeable to magnetic fields and to radiofrequency waves,

means for generating a monitoring plasma, the light from which is to be analyzed, in the internal space of the axial excroissance,

at least one sensor placed on the wall of the axial excroissance, for detecting the light radiation emitted by the monitoring plasma,

means for analyzing the emission spectrum, placed on the outside of the gastight wall and receiving the light that is emitted by the monitoring plasma and collected by the sensor,

a means of generating, in the internal space of the axial excroissance, a field oriented transversely to the direction I-I of propagation of the light flux to the sensor and ensuring that the flux of ionized particles and electrons from the monitoring plasma are deflected away from the sensor, said means being placed close to and on the outside of the gastight peripheral wall of the axial excroissance, so as to generate a field at the end of the axial excroissance on the opposite side from the open end and in the immediate vicinity of the sensor.

The sensor that detects the light radiation emitted by the monitoring plasma may for example include a portion of the wall of the axial excroissance that is transparent to the light emitted by a plasma, in particular the portion of the wall closing off one of the ends of the axial excroissance. Thanks to the positioning of the sensor at the end of the axial excroissance on the opposite side from the opening into the chamber, the means of generating a field may be placed on the outside of the axial excroissance, while still being close to the zone of the internal space of the axial excroissance located upstream of the sensor in the direction of propagation of the light and of the ionized particles emanating from the plasma. In this way, the generating means can create a field upstream of the sensor in order to deflect the flux of ionized particles and electrons of the plasma and thus prevent ionized particles from reaching the sensor and being deposited thereon. A sufficient area of the wall of the axial excroissance must be left between the field and the opening for communication with the chamber, in such a way that the ionized particles are deposited on the wall of the axial excroissance and do not end up polluting the chamber.

Plasma-generating means are provided for ionizing the gaseous species to be monitored in the internal space of the tube. To generate the plasma, an external excitation antenna, supplied by a high-frequency generator, may be provided in order to produce a high-frequency electromagnetic excitation field. The field passes through the peripheral wall of the axial excroissance of the chamber itself, said wall being preferably made of an electrically nonconducting material such as quartz, glass, BK7, sapphire, or a ceramic (ZrO₂, Cr₂O₃, etc).

According to a first embodiment of the invention, the generating means is a means of generating a magnetic field. The electrons of the plasma, which ionize the particles, are trapped by the magnetic field and cannot pass through the magnetic barrier formed by the transverse magnetic field. They therefore cannot ionize particles beyond the magnetic barrier.

The peripheral wall of the axial excroissance is made of a material exhibiting satisfactory nonmagnetic properties so as to be permeable to magnetic fields.

According to one advantageous embodiment, two magnets are provided, these being placed respectively on either side of the axial excroissance of the chamber and attracting each other. Thus, the magnetic fields created by the two magnets are added in the internal zone of the axial chamber excroissance upstream of the sensor.

In this embodiment, the magnets may be pressed against the external face of the peripheral wall of the axial chamber excroissance, said magnets being held in place by their own mutual magnetic attraction force.

In this way, the magnets can be easily removed, for example in order to dismantle the chamber part constituting the axial chamber excroissance, for example during a cleaning operation.

An improvement may be obtained by ensuring that the magnets are shrouded on the outside by an annular outer component made of nonmagnetic material, in order to provide the mechanical retention function, or by an annular outer component made of magnetic material in order to provide the dual function of mechanical retention and magnetic shield by closing up the magnetic field lines around the axial chamber excroissance.

The magnet or magnets may be permanent magnets. Alternatively, the magnet or magnets may be electromagnets.

According to a second embodiment of the invention, the generating means is a means of generating an electric field.

The axial excroissance is preferably, but not exclusively, produced in the form of an axial tube, designed to be attached and in communication with a chamber in which the gaseous species to be monitored are present, the tube being closed at one end by a wall portion and being opened at the opposite end, in order for connection to the chamber, and plasma-generating means being provided in order to ionize the gaseous species to be monitored in the internal space of the tube.

This device can be used to analyze the gas mixture contained in a chamber, which may in particular be a process chamber, whether the process involved operates with or without a plasma, or in a duct, but also in any other volume whose atmosphere it is desired to analyze.

The opening into the axial excroissance is preferably made in the wall of said chamber.

The subject of the invention is also an installation for treating a semiconductor substrate, which includes the monitor device described above, communicating with a process chamber, the monitor device thus being designed to monitor the gaseous species within the actual process chamber.

A further subject of the invention is an installation for treating a semiconductor substrate, which includes the monitor device described above, communicating with a vacuum line.

### BRIEF DESCRIPTION OF THE DRAWINGS

Other objects, features and advantages of the present invention will become apparent from the following description of particular embodiments, given in relation to the appended figures in which:

FIG. 1 is a schematic view illustrating a monitor device according to a first embodiment, in the form of an independent device connected to a process chamber;

FIG. 2 illustrates schematically the monitor device according to the embodiment of FIG. 1, suitable for monitoring the gases in a vacuum line which is itself connected to a process chamber;

FIG. 3 is a partial schematic side view of a monitor device according to the invention, in longitudinal section on a larger scale;

FIG. 4 is in transverse section along the plane A-A of FIG. 3;

FIG. 5 is a partial schematic top view in cross section on a larger scale of the device of FIG. 4, illustrating the deflection of the ionized particles;

FIG. 6 illustrates the spectrum of air obtained by means of a device according to the prior art; and

FIG. 7 illustrates the spectrum of air obtained by means of the device according to the invention.

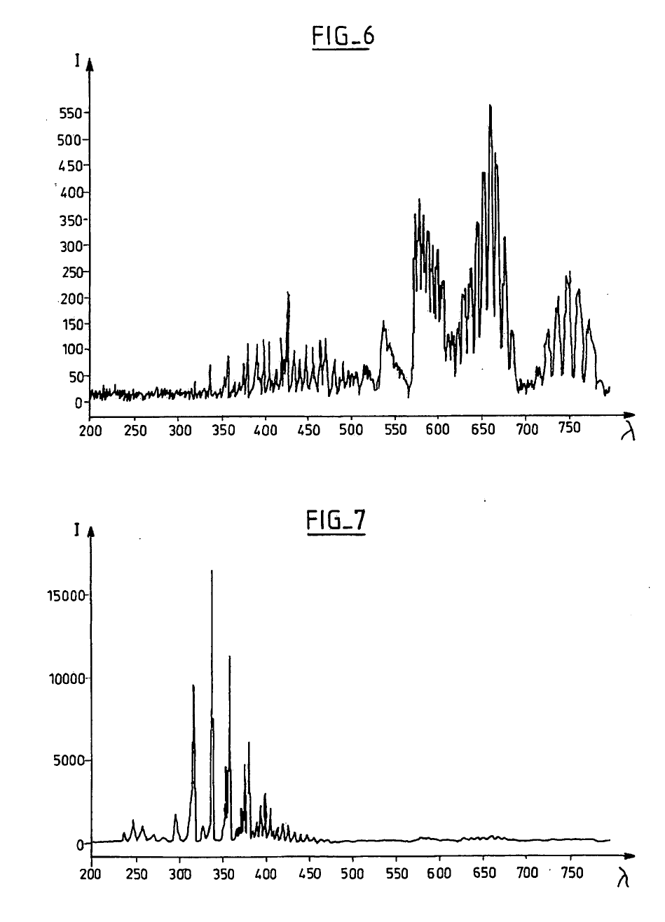

In FIGS. 6 and 7, the intensity of the lines in arbitrary units (a.u.) is plotted on the y-axis and the wavelength in nanometers (nm) is plotted on the x-axis. The spectra of FIGS. 6 and 7 were obtained with the same setting of the optical spectrometer.

### DETAILED DESCRIPTION OF THE PREFERRED EMBODIMENTS

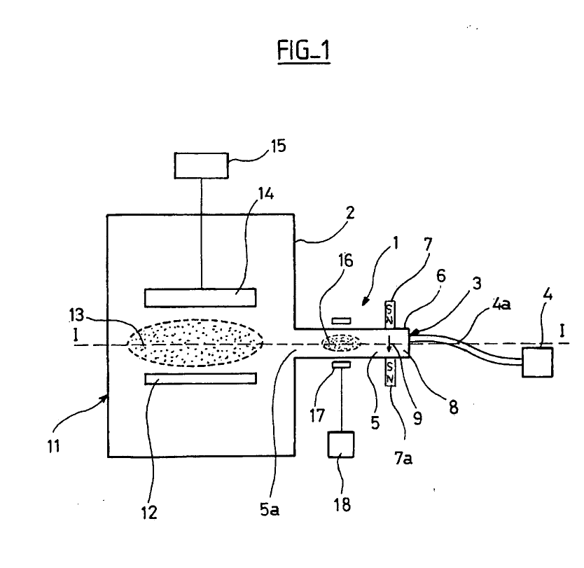

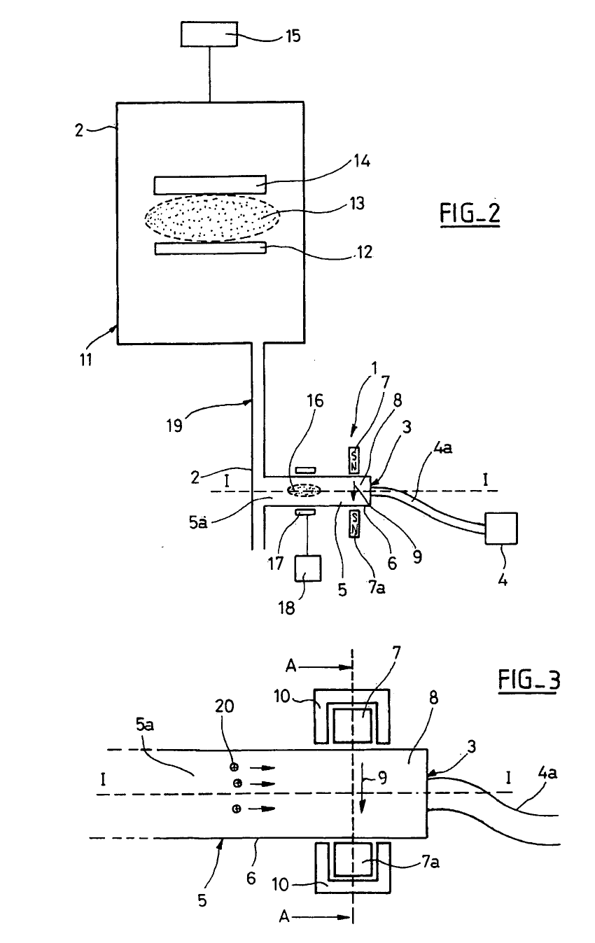

In the embodiments illustrated in FIGS. 1 and 2, a monitor device 1 according to the invention is intended to monitor, by optical emission spectroscopy, gaseous species contained in a chamber isolated from the outside by a gastight wall 2. The wall 2 includes at least one sensor 3 comprising a portion of the wall 6 which is gastight but transparent to the light emitted by a plasma.

Emission spectrum analysis means 4 are placed outside the gastight wall 2 and receive the light emitted by a plasma and transmitted via the sensor 3. The light radiation passes in succession through the end portion of the wall 6 and then a transmission means such as an optical fiber 4a, the sensor 3 in this case comprising the end portion of the light-transparent wall 6 and the optical fiber 4a.

In these embodiments, the sensor 3 is placed at the end of an axial excroissance 5 bounded by a gastight peripheral wall 6 permeable to magnetic fields that develop along the axis I-I away from the main part of the gastight wall 2 of the chamber.

The peripheral wall 6 of the axial excroissance 5 may advantageously be made of a material exhibiting satisfactory nonmagnetic properties so as to be permeable to magnetic fields, but also permeable to radiofrequency waves. Preferably, the wall 6 is made of an electrically nonconducting material such as, for example, quartz, glass, BK7, sapphire or a ceramic (ZrO₂, Cr₂O₃, etc).

The axial excroissance 5 is of tubular shape, but it may also have any other shape. In the case shown in the figures, the tube 5 is closed at a first end by the wall portion 6 included in the sensor 3, and it is open at the second end 5a for passage of the gases to be monitored.

The monitor device 1 further includes, placed near and on the outside of the gastight peripheral wall 6 of the axial excroissance 5, at least one means of generating a field, which may be a magnetic field or an electric field, such as a magnet 7 that generates, in the internal space 8 of the axial excroissance 5, a magnetic field 9 oriented transversely to the direction of propagation of the light flux to the sensor 3. The direction of propagation of the useful light flux is illustrated by the longitudinal axis I-I of the axial excroissance 5. The transverse magnetic field 9 deflects the flux of ionized particles from the plasma, keeping them away from the sensor 3.

In the embodiment illustrated in FIGS. 1 and 2, the monitor device 1 comprises two magnets 7 and 7a for generating, in the internal space 8 of the axial excroissance 5, a transverse magnetic field 9 that deflects the ionized particles away from the sensor 3. The magnets 7 and 7a are placed respectively on either side of the axial excroissance 5 and attract each other.

For example, the magnets 7 and 7a may be simply pressed against the external face of the peripheral wall 6 of the axial excroissance 5, said magnets being held in place by their own mutual magnetic attraction force.

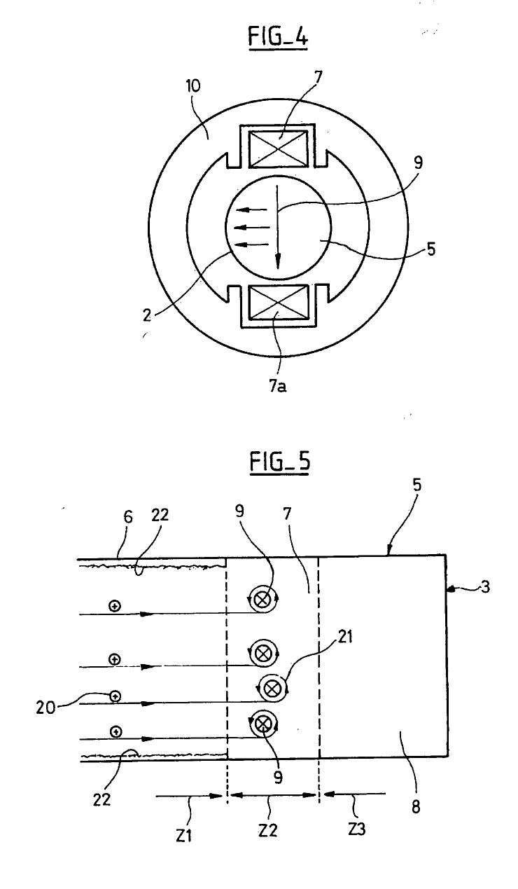

To concentrate the magnetic field 9 in the internal space 8 of the axial excroissance 5, thus encouraging the charged particles to be deflected away from the sensor 3, the magnets 7 and 7a may advantageously be shrouded on the outside, as illustrated in FIGS. 3 and 4, by an annular outer component 10 made of magnetic material, forming an armature that provides the magnetic shielding function and closes up the magnetic field lines around the axial excroissance 5.

The embodiment illustrated in FIG. 1 will now more particularly be considered.

In this case, the monitor device 1 is attached to a process chamber 11 in which processes for treating a substrate 12 are carried out. The process chamber 11 generally contains process gases at low pressure, the presence and the concentration of said gases it is desired to monitor.

The monitor device 1 according to the invention, in the form of a removable axial tube, is attached to and in communication with the enclosure formed by the process chamber 11 in which the gaseous species to be monitored are present. The monitor device 1 itself includes means for generating a monitoring plasma 16, the light from which will be analyzed by the emission spectrum analysis means 4. The monitor device 1 thus includes an excitation antenna 17 supplied by a power generator 18, which excites the charged gaseous particles present in the internal space 8 of the axial chamber excroissance 5 in order to create a monitoring plasma 16. The light emitted by the monitoring plasma 16 propagates along the axis I-I as far as the sensor 3 and then, via the optical fiber 4a, to the emission spectrum analysis means 4.

The device illustrated in FIG. 2 will now be considered.

This figure again shows the monitor device 1 in the embodiment of FIG. 1, which is a device connected to a chamber formed by a vacuum line 19 which is itself connected to a process chamber 11.

Again there are the means for generating a monitoring plasma 16 in the internal space 8 of the axial excroissance 5, namely an excitation antenna 17 and a power generator 18.

FIG. 2 again shows the other constituent means of the monitor device 1, as illustrated previously in FIG. 1, these means being identified by the same numerical references.

In this FIG. 2, the monitor device 1 is thus designed to monitor the gaseous species contained in the vacuum line 19.

FIGS. 3 and 4, which illustrate an embodiment in which the magnets 7 and 7a are held in place by an annular outer component 10, will now be considered.

According to a first embodiment, the annular outer component 10 is made of nonmagnetic material, for example aluminum or plastic, in order to provide the function of mechanically retaining the magnets 7 and 7a.

According to a second embodiment, the annular outer component 10 may be made of magnetic material, in order to provide the dual function of mechanical retention and magnetic shielding by closing up the magnetic field lines around the axial excroissance 5.

In all cases, the magnet or magnets 7 and 7a may be permanent magnets.

Alternatively, provision may be made for the magnet or magnets 7 and 7a to be electromagnets supplied with electrical power by a source of electrical power (not illustrated in the figures).

In the embodiments illustrated in FIGS. 1 and 2, the monitor device 1 is an attached device provided with means of generating a monitoring plasma 16, comprising the excitation antenna 17 and the power generator 18. In addition, the peripheral wall 6 must be made of an electrically nonconducting material, allowing the electromagnetic waves for exciting the plasma, which are generated by the excitation antenna 17 and the power generator 18, to pass through it. In this case, it may be advantageous for the axial excroissance 5 to be in the form of a tube, the peripheral wall 6 of which is made of an electrically nonconducting material such as for example quartz, glass, BK7 or sapphire.

The operation of the monitor device 1 according to the invention is as follows.

The emission spectrum analysis means 4, such as an optical spectrometer, receive, via an optical fiber 4a or any other appropriate transmission means, the light emitted by a monitoring plasma 16 and collected by the sensor 3, said plasma containing the gaseous species to be analyzed. The light propagates along the axial excroissance 5, reaches the wall 6 at the sensor 3 and propagates via the optical fiber 4a to the optical spectrometer 4. The presence of a plasma 16 simultaneously implies the presence of ionized particles that are liable to create deposits on the sensor 3, which gradually obscure it, thus corrupting the measured optical spectrum.

FIG. 6 illustrates the optical emission spectrum of a plasma in air, measured by means of the sensor of a device according to the prior art, such as for example that described in document U.S. Pat. No. 6,643,014 incorporated here for reference, which relates to deposition of ionized particles. It may be seen that the deposition substantially distorts the spectrum. The UV rays are extremely weak as they are completely absorbed by the deposit that is formed inside the tube, on the internal face of the sensor (maximum density 550 a.u.). At worst, the sensor can become completely opaque and completely prevent the correct operation of the detection system.

FIG. 7 illustrates the optical emission spectrum of a plasma in air measured by means of a sensor comprising a transparent portion of the wall of a device according to the invention that is clean and free of any deposit of ionized particles. The UV lines are clearly apparent as they encounter no obstacle (maximum intensity 16 000 a.u.). The device according to the invention prevents the ionized particles from reaching the sensor, keeping it perfectly clean and allowing the sensitivity of the measurements to remain optimum. The detection sensitivity is about 100 times better than in the case of FIG. 6.

FIGS. 3 to 5 illustrate ionized particles 20 present in the internal space 8 of the axial excroissance 5. The particles move in all directions, certain ionized particles 20 tending to move axially toward the sensor 3 in the zone Z1 upstream of the magnets 7 and 7a. The magnetic field 9 generated between the magnet 7 (which is placed behind the axial excroissance 5 and represented by a dashed line) and the magnet 7a, upstream of the sensor 3, produces a deflection force on these ionized particles 20 that tends to impress thereon a circular movement 21 winding around the transverse magnetic field lines 9, as shown symbolically in a schematic manner in the zone Z2 of FIG. 5.

In practice, the magnets 7 and 7a produce a magnetic barrier that prevents the ionized particles 20 and electrons in the zone Z3 from propagating beyond the zone Z2 occupied by the magnetic field 9. Thus, any particles 22 are deposited on the peripheral wall 6 upstream of the zone Z2 occupied by the magnets 7 and 7a. It will be understood that the portion of the device located upstream of the zone Z2 must have an area sufficient to allow the particles to be deposited therein, without the risk of them being deposited beyond the opening 5a of the device, which would be liable to pollute the chamber. Consequently, the magnetic field must be generated as far away as possible from the open end 5a of the device 1 and in the immediate vicinity of its closed end where the sensor 3 is located. Thus, the ionized particles 20 do not reach the sensor 3, and thus the correct measurement of the optical emission spectrum as illustrated in FIG. 7 is maintained.

According to the invention, the chamber containing the gases to be analyzed and the axial excroissance 5 contain no foreign element, such as antennas, magnets or the like, which are liable to pollute the gases contained inside the chamber. The gases contained inside the chamber are only in contact with the walls 2 or 6, so that the monitor device 1 according to the invention is perfectly neutral with respect to the processes taking place in the chamber.

In the embodiments shown in FIGS. 1 and 2, the monitor device 1 can be readily removed, by removing the magnets 7 and 7a and then the tube constituting the axial excroissance 5 if necessary for cleaning purposes.

Thanks to the presence of the magnets 7 and 7a, the sensor 3 is unaffected by the presence of an internal plasma 16 and it is no longer necessary for the sensor to be frequently cleaned.

The present invention is not limited to the embodiments that have been explicitly described, but rather includes various alternative and generalized versions thereof, which are within the competence of a person skilled in the art.

1. A monitor device for monitoring gaseous species contained in a chamber by optical emission spectroscopy, which device comprises:
an axial excroissance joined to said chamber via an open end and bounded by a gastight peripheral wall permeable to magnetic fields and to radiofrequency waves;
means for generating a monitoring plasma, the light from which is to be analyzed, in the internal space of the axial excroissance;
at least one sensor on the wall of the axial excroissance, for detecting the light radiation emitted by the monitoring plasma; and
means for analyzing the emission spectrum, placed on the outside of the gastight wall and receiving the light that is emitted by the monitoring plasma and collected by the sensor,
which device further includes a means of generating, in the internal space of the axial excroissance, a field oriented transversely to the direction I-I of propagation of the light flux to the sensor and ensuring that the flux of ionized particles and electrons from the monitoring plasma are deflected away from the sensor, said means being placed close to and on the outside of the gastight peripheral wall of the axial excroissance, so as to generate a field at the end of the axial excroissance on the opposite side from the open end and in the immediate vicinity of the sensor.

2. The device as claimed in claim 1, wherein the sensor includes a portion of the wall of the axial excroissance that is transparent to the light emitted by the monitoring plasma.

3. The device as claimed in claim 2, wherein the sensor includes the portion of wall closing off one of the ends of the axial excroissance.

4. The device as claimed in claim 1, wherein the peripheral wall of the axial excroissance of the chamber is made of an electrically nonconducting material.

5. The device as claimed in claim 4, in which the material of the peripheral wall of the axial excroissance of the chamber is chosen from quartz, glass, BK7 and sapphire.

6. The device as claimed in claim 1, in which the generating means is a means of generating a magnetic field.

7. The device as claimed in claim 6, wherein the peripheral wall of the axial excroissance is made of a material exhibiting satisfactory nonmagnetic properties so as to be permeable to magnetic fields.

8. The device as claimed in claim 6, which includes two magnets placed respectively on either side of the axial excroissance and attracting each other.

9. The device as claimed in claim 8, wherein the magnets are pressed against the external face of the peripheral wall of the axial excroissance, said magnets being held in place by their own mutual magnetic attraction force.

10. The device as claimed in claim 8, wherein the magnets are shrouded on the outside by an annular outer component, either made of nonmagnetic material, in order to provide the mechanical retention function, or made of magnetic material in order to provide the dual function of mechanical retention and magnetic shield by closing up the magnetic field lines around the axial excroissance.

11. The device as claimed in claim 8, wherein the magnet or magnets are permanent magnets.

12. The device as claimed in claim 8, wherein the magnet or magnets are electromagnets.

13. The device as claimed in claim 1, in which the generating means is a means of generating an electric field.

14. The device as claimed in claim 1, in which the axial excroissance of the chamber is produced in the form of an axial tube, designed to be attached and in communication with a chamber in which the gaseous species to be monitored are present, the tube being closed at one end by a wall portion and being opened at the opposite end, in order for connection to the chamber, and plasma-generating means being provided in order to ionize the gaseous species to be monitored in the internal space of the tube.

15. The device as claimed in claim 1, wherein the opening into the axial excroissance is made in the wall of said chamber.

16. An installation for treating a semiconductor substrate, which includes a monitor device as claimed in claim 1, communicating with a process chamber, the monitor device thus being designed to monitor the gaseous species within the actual process chamber.

17. An installation for treating a semiconductor substrate, which includes a monitor device as claimed in claim 1, communicating with a vacuum line.
